(19) United States
(12) Patent Application Publication
(10) Pub. No.: US 2018/0240288 A1
(43) Pub. Date: Aug. 23, 2018

(54) SYSTEM AND METHOD FOR AUTOMATED SERVICING OF VEHICLES

(71) Applicant: Faraday&Future Inc., Gardena, CA (US)

(72) Inventors: Juan Pablo Samper, Mountain View, CA (US); Gowtham Ranganathan, San Jose, CA (US)

(21) Appl. No.: 15/690,177

(22) Filed: Aug. 29, 2017

Related U.S. Application Data
(60) Provisional application No. 62/381,522, filed on Aug. 30, 2016.

(51) Int. Cl. G07C 5/00; G07C 5/08; G05D 1/00

(52) U.S. Cl. CPC G07C 5/006; G05D 1/0066; G07C 5/0816; G07C 5/0808

(57) ABSTRACT

A system that performs a method is disclosed. While monitoring a vehicle's operations, the system detects a vehicle issue. The system determines a cause of the vehicle issue by performing a lookup on a data structure, and determines whether the cause of the vehicle issue requires immediate repairs. In response to the determination: in accordance with a determination that the cause of the vehicle issue requires immediate repairs, the system addresses the vehicle issue at a current time. In accordance with a determination that the cause of the vehicle issue does not require immediate repairs, the system adapts the operation of the vehicle based on the cause of the vehicle issue, and addresses the vehicle issue at a later time.

### CROSS-REFERENCE TO RELATED APPLICATIONS

This application claims the benefit of U.S. Provisional Application No. 62/381,522, filed Aug. 30, 2016, the entirety of which is hereby incorporated by reference.

### FIELD OF THE DISCLOSURE

The various embodiments of the present invention relate generally to automated servicing of vehicles.

### BACKGROUND OF THE DISCLOSURE

Vehicles, especially automobiles, generally base maintenance determinations on odometer information. However, a particular vehicle may require additional or less maintenance depending on the use of the vehicle. This can result in a particular vehicle being overserved or underserved. Moreover, troubleshooting vehicle issues and coordinating repairs can be time consuming. Therefore, a solution for automating regular vehicle maintenance and other repairs is desirable.

### SUMMARY OF THE DISCLOSURE

Examples of the disclosure are directed to automating the servicing of vehicles. A vehicle can monitor sounds, temperature, fluid information, wheel properties, sensor disparities, and external information to detect vehicle issues and determine the causes of those issues. A vehicle in accordance with an embodiment of the present invention can identify the necessary repairs to resolve those vehicle issues. A vehicle in accordance with an embodiment of the present invention can also automatically make those repairs and/or automatically coordinate those repairs. In this way, automated servicing of vehicles can be achieved.

### BRIEF DESCRIPTION OF THE DRAWINGS

FIG. 1 illustrates an exemplary process for making intelligent maintenance determinations.

FIG. 2 illustrates an exemplary process for detecting a vehicle issue and/or for determining the cause of the vehicle issue according to examples of the disclosure.

FIG. 3 illustrates an exemplary process for determining the cause of a vehicle issue based on sounds according to examples of the disclosure.

FIG. 4 illustrates an exemplary process for making vehicle repairs according to examples of the disclosure.

FIG. 5 illustrates an exemplary process for automatically scheduling an appointment for repairs according to examples of the disclosure.

FIG. 6 illustrates an exemplary process for selecting a fleet vehicle to drive a particular route according to examples of the disclosure.

FIG. 7 illustrates an exemplary system block diagram of vehicle control system according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

Vehicles owners, especially automobiles, generally determine maintenance or repair schedules using odometer information of the vehicle. Similarly, vehicles that are preprogrammed to remind owners of maintenance events typically use odometer information of a vehicle as triggers of such reminders. However, a particular vehicle may require additional or less maintenance depending on the use of the vehicle. For example, a vehicle that is operated in extreme driving conditions (e.g., driven on long driving routes, carrying heavy payloads, and/or with little to no downtime between trips), may require maintenance more frequently than a vehicle that is simply used for a daily 20-mile commute to and from work. Moreover, troubleshooting vehicle issues and coordinating repairs can be time consuming. Examples of the disclosure are directed to automating the servicing of vehicles. A vehicle may use the data from sensors placed throughout the vehicle to determine when maintenance is required. These sensors can also be used to troubleshoot unexpected vehicle issues. Additionally, autonomous vehicles can either repair themselves or coordinate when and/or where to drive the vehicle for repairs. In this way, autonomous driving vehicles can automatically take care of repairs and maintenance issues during the vehicle's downtime (e.g., when the vehicle would normally sit idle).

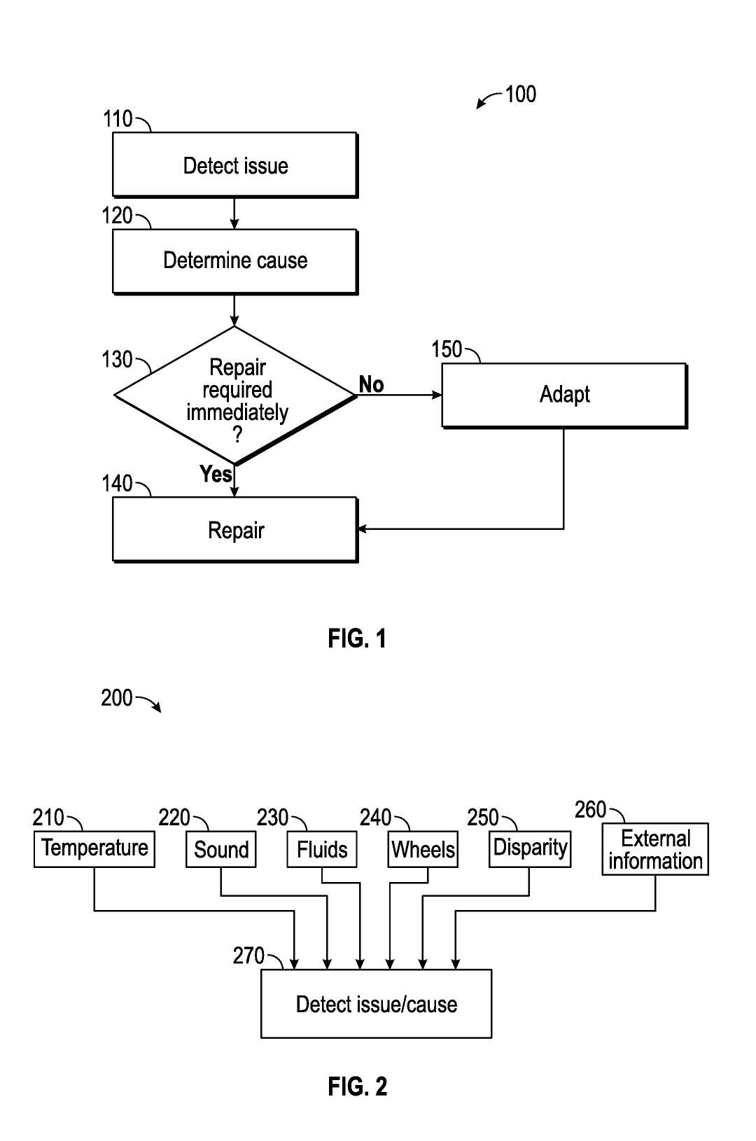

FIG. 1 illustrates an exemplary process for making intelligent maintenance determinations according to examples of the disclosure. Process 100 can be performed continuously or repeatedly by the vehicle during driving operations. Process 100 can also be invoked by the user or run at vehicle start up (e.g., when the vehicle is powered on).

At step 110, process 100 can detect vehicle issues (as described in further detail below). These vehicle issues can include regular maintenance issues (e.g., the need to change the vehicle's tires, air filters, oil, brake fluid, electric vehicle battery fluids (e.g., polyalphaolefin (PAO)), the correct operation of brake pressure refill, and/or other vehicle fluid related issues), motor issues, sensor issues, battery issues, software issues (e.g., system updates or security breaches such as malware), issues within the cabin of the vehicle (e.g., issues with displays, controls such as button or touchscreens, sound systems, air conditioning (AC) systems, or interior refrigerators), wireless communications issues (e.g., issues with Bluetooth, Wi-Fi, RFID, or cellular communications), or any other issues with the vehicle. In some examples, the vehicle may be equipped with various sensors to monitor the performance of the vehicle. For example, the vehicle can be equipped with systems and sensors for determining its location such as Global Navigation Satellite System (GNSS) (e.g., Global Positioning System (GPS), BeiDou, Galileo, etc.) receivers, optical cameras, ultrasound sensors, radar sensors, LIDAR sensors, cellular positioning systems, maps, cloud services, and any other system or sensor that can be used to determine a vehicle's location. This location information can be used to determine if the vehicle veers left or right during driving maneuvers (e.g., due to the wheels being misaligned). This location information can also be used to determine whether the vehicle skids during driving maneuvers, has trouble stopping, etc. The location information from these various systems and sensors can also be used to detect a problem with one of those systems and sensors by comparing the output from each of those systems and sensors for discrepancies.

In some examples, process 100 can notify the driver or a designated third party of the vehicle issue. In some examples, the vehicle may provide a haptic indicator (e.g., one or more vibrating seats and/or seatbelts). In some examples, the vehicle can provide a visual alert through the vehicle's one or more display systems (e.g., control panel, entertainment system, heads up display system, or infotainment system). In some examples, the vehicle can provide an audio alert through the vehicle's sound system. In some examples, the alert can include activating visual and/or audio indicators. Visual indicators can include one or more of a headlight, a hazard light, a smog light, or any light source on the outside or the inside of the vehicle. The audio indicators can include one or more of a horn, a speaker, an alarm system, and/or any other sound source in the vehicle. In some examples, the alert can be a phone call, text message, email, or any form of electronic or audible/visual communication to an electronic device associated with the vehicle's owner, driver, passenger(s), or any third party (e.g., smartphone and/or other electronic device). The designated third party can be the vehicle's owner, a call center, a 911 operator, and/or any other third party. In some examples, the designated third party can be located in the vehicle or can be located remotely from the vehicle.

At step 120, process 100 can determine the cause of the vehicle issue that was detected at step 110. In some examples, the vehicle can maintain in its memory a data structure (e.g., a database, a hash table, a binary search tree, a data file, an XML file, or a binary decision diagram) of vehicle issues and the corresponding causes of each of those vehicle issues. In some examples, the data structure can also include information about the repairs for the causes of each of the vehicle issues (e.g., how to repair the cause of the vehicle issues or where to have the vehicle repaired). Process 100 can perform a lookup of a vehicle issue on the data structure (e.g., a database lookup) to determine the cause of the vehicle issue at step 120. In some examples, process 100 can include additional information from the vehicle's various systems and sensors (e.g., location information, vehicle velocity, vehicle heading, or map information), or external information (e.g., information received from other vehicles or remote systems such as weather information, map information, or road conditions) or any other additional information that can be required to perform the lookup on the data structure. For example, process 100 can determine that the wheels of the vehicle are misaligned after executing a database lookup for the vehicle issue of veering to the left during vehicle maneuvers. Such a database lookup can include information about the vehicle's heading, locations over time, road conditions, or any other information from the vehicle's sensors or other external sources that may be necessary to diagnose the cause of the vehicle issue. In another example, process 100 can determine that the wheels are wearing out after executing a lookup on the data structure (e.g., a database lookup) for the vehicle issue of skidding during turning maneuvers. Such a database lookup can include information about the weather and/or road conditions (e.g., dry paved road). In some examples, the data structure can be stored remotely (e.g., remote database(s) and/or cloud services), and the vehicle can perform the data structure lookup wirelessly (e.g., through a Wi-Fi connection or cellular connection). In some examples, the data structure may be updated by the vehicle, other vehicles, the driver, a mechanic, a system administrator, and/or anyone troubleshooting a vehicle issue. In this way, a comprehensive data structure of vehicle issues and corresponding causes of those vehicle issues may be maintained and shared among many vehicles.

In some examples, process 100 can notify the driver or a designated third party of the cause of the vehicle issue. In some examples, the vehicle can provide a visual alert through the vehicle's one or more display systems (e.g., control panel, entertainment system, heads up display system, or infotainment system). In some examples, the vehicle can provide an audio alert through the vehicle's sound system. In some examples, the alert can be a phone call, text message, email, or any form of electronic or audible/visual communication to an electronic device associated with the vehicle's owner, driver, passenger(s), or any third party (e.g., smartphone and/or other electronic device). The designated third party can be the vehicle's owner, a call center, a 911 operator, and/or any other third party. In some examples, the designated third party can be located in the vehicle or can be located remotely from the vehicle.

At step 130, process 100 can determine whether the vehicle issue (or the cause of the vehicle issue) requires immediate repairs. For example, process 100 can detect extremely low tire pressure in one tire and determine that the tire is flat, requiring immediate repair. At this point, process 100 would transition to step 140 to repair the tire (e.g., as described below with references to FIG. 4). In another example, process 100 can detect low tire pressure on a run-flat tire and/or detect that the tire is slowly losing air, requiring repair within the next 100 miles. At this point, process 100 would transition to step 150.

At step 150, process 100 can adapt the operation of the vehicle based on the cause of the vehicle issue. For instance, in the example described above where process 100 detects low tire pressure on a run-flat tire and/or detects that the tire is slowly losing air, process 100 may set a maximum speed for the vehicle (e.g., 55 miles per hour or any other safe speed for the detected tire pressure and/or run-flat tire model). In some examples, process 100 can set the maximum distance the vehicle may drive (e.g., set a maximum threshold distance of 90 miles or any other safe distance) before requiring that the repairs be made (e.g., before transitioning to step 140), and avoid driving routes longer than that distance. In another example, the vehicle can be configured with one or more battery strings (e.g., an interconnected string of one or more batteries as described in U.S. Provisional Patent Application No. 62/249,136, for example), and process 100 can detect an issue with vehicle power (e.g., low power, slow charge, or quick discharge) at step 110, determine that the cause of the issue is an overheated a battery or battery string at step 120, determine that repairs are not immediately required at step 130, and adapt the operation of the vehicle by taking the overheated battery or battery string offline at step 150 and/or avoiding routes that involve driving in hot weather conditions. In another example, process 100 can detect that the vehicle can only charge its power up to 30% of the battery capacity (or any level below maximum capacity) at step 110, determine that the cause is one or more battery and/or battery string malfunctions (e.g., several blown out cells) at step 120, determine that repairs are not immediately required at step 130, and adapt the operation of the vehicle by avoiding certain terrains (e.g., mountains or hilly terrains), avoiding heavy payloads or cargo, avoiding driving above a particular speed limit (e.g., above 40 miles per hour), avoiding heavy acceleration (or severe stop and go driving), or avoiding any other driving operations or routes that are power intensive (e.g., consume too much power) at step 150. In another example, the vehicle can include a plurality of cameras and/or sensors around the exterior of the vehicle to capture images or data of the vehicle's surroundings, and process 100 can detect an issue with the one or more of the cameras (e.g., difficulty detecting objects) at step 110, determine that the cause of the issue is fog at step 120, determine that repairs are not immediately required (or not required at all) at step 130, and adapt the operation of the vehicle by either rerouting the vehicle (e.g., to avoid the fog), taking the plurality of cameras offline, and/or relying on the data from a plurality of other sensors instead. In another example, process 100 can detect the vehicle issue of skidding during turning maneuvers at step 110, determine that the cause of the issue is tire wear at step 120, determine that repairs are not immediately required (e.g., not required for another 1,000 miles) at step 130, and adapt the operation of the vehicle by reducing the vehicle's speed during turning maneuvers, avoiding particular weather conditions (e.g., rainy, snowy, or icy conditions), and/or avoiding driving routes longer than a threshold distance (e.g., avoiding trips longer than 1,000 miles). In another example, the vehicle could be equipped with one or more sensors to measure the level, consistency, viscosity, and/or any other properties of the vehicle's fluids, detect that the oil level is low at step 110, determine that the cause is normal wear and tear at step 120, determine that repairs are not immediately required (e.g., not required for another 600 miles) at step 130, and adapt the operation of the vehicle to avoid driving routes that are longer than threshold distance (e.g., 600 miles). In some examples, the driver can manually trigger when the repairs are made (e.g., when process 100 transitions to step 140). In some examples, the driver can manually trigger when the repairs are made through a control system such as a button, a touch screen, a voice command, a computer, a smartphone, an electroencephalogram (EEG), or any device or system that allows user input to be entered. In some examples, how the operation of the vehicle is adapted can be recorded (e.g., stored locally and/or remotely in a database or any other data structure). In some examples, this information can be used to manage a fleet of vehicles (e.g., as described below with reference to FIG. 6).

In some examples, process 100 can notify the driver or a designated third party of how the operation of the vehicle is or will be adapted. In some examples, the vehicle can provide a visual alert through the vehicle's one or more display systems (e.g., control panel, entertainment system, heads up display system, or infotainment system). In some examples, the vehicle can provide an audio alert through the vehicle's sound system. In some examples, the alert can be a phone call, text message, email, or any form of electronic or audible/visual communication to an electronic device associated with the vehicle's owner, driver, passenger(s), or any third party (e.g., smartphone and/or other electronic device). The designated third party can be the vehicle's owner, a call center, a 911 operator, and/or any other third party. In some examples, the designated third party can be located in the vehicle or can be located remotely from the vehicle.

FIG. 2 illustrates an exemplary process 200 for detecting a vehicle issue and/or for determining the cause of the vehicle issue according to examples of the disclosure. Process 200 can be performed continuously or repeatedly by the vehicle during driving procedures. In some examples, process 200 can implement steps 110 and/or 120 of process 100 (e.g., as described above with reference to FIG. 1).

At step 210, process 200 monitors the temperature of various components of the vehicle such as the engine, radiator, a battery or a battery string, and/or any other component of the vehicle through one or more sensors positioned at or near those various components. At step 220, process 200 monitors sound(s) from various components of the vehicle such as the engine, wheels, transmission, suspension, and/or any other component of the vehicle through one or more sensors positioned at or near those various components. At step 230, process 200 monitors the properties of the vehicle's fluids (e.g., the oil, brake fluid, transmission fluid, power steering fluid, and radiator fluid) such as the level, consistency, viscosity, whether brake pressure prefill is operating correctly, and/or any other property of the vehicle's fluids through one or more sensors and/or cameras positioned in or near those fluids. At step 240, process 200 monitors wheel properties such as tire pressure, tire wear, tire size, wheel alignment, and/or any other wheel properties through one or more sensors and/or cameras positioned in or near each wheel and/or tire. At step 250, process 200 monitors the vehicle system and/or sensor disparities (e.g., discrepancies). For examples, process 200 can monitor the vehicle's sensors by comparing their output to detect sensor disparities. For example, process 200 can compare the output from a GPS receiver to the output from other location systems and/or sensors, and monitor any disparities between those outputs (e.g., monitor any differences between location determinations). Such discrepancies can evidence a vehicle issue (e.g., a problem with a GPS receiver). In another example, process 200 can monitor vehicle responses to vehicle operation instructions at step 250 (e.g., compare vehicle responses to any expected vehicle responses). For example, if the expected vehicle response for the vehicle operation instruction to accelerate at 30% is for the vehicle to drive at 40 miles per hour, process 200 can monitor whether the vehicle's actual speed (e.g., the actual response) matches that expected response. At step 260, process 200 can monitor external information (e.g., information received from other vehicles and/or remote systems such as weather information, map information, and/or road conditions). In some examples, process 200 can monitor the output from door sensors, light sensors, air floor sensors, and/or any other sensors on the vehicle. At step 270, process 200 detects a vehicle issue based on information from one or more of steps 210, 220, 230, 240, 250, and 260 (e.g., as described above with reference to FIG. 1). At step 270, process 200 can also determine the cause of a vehicle issue by performing a lookup of the vehicle issue on a data structure of vehicle issues and corresponding causes of those vehicle issues (e.g., as described above with reference to FIG. 1). In some examples, process 200 can perform the lookup on the data structure of step 120 from process 100 (e.g., as described above with reference to FIG. 1) based on information from one or more of steps 210, 220, 230, 240, 250, and 260.

It should be appreciated that in some embodiments a learning algorithm can be implemented such as an as a neural network (deep or shallow, which may employ a residual learning framework) and be applied instead of, or in conjunction with another algorithm described herein to solve a problem, reduce error, and increase computational efficiency. Such learning algorithms may implement a feedforward neural network (e.g., a convolutional neural network) and/or a recurrent neural network, with supervised learning, unsupervised learning, and/or reinforcement learning. In some embodiments, backpropagation may be implemented (e.g., by implementing a supervised long short-term memory recurrent neural network, or a max-pooling convolutional neural network which may run on a graphics processing unit). Moreover, in some embodiments, unsupervised learning methods may be used to improve supervised learning methods. Moreover still, in some embodiments, resources such as energy and time may be saved by including spiking neurons in a neural network (e.g., neurons in a neural network that do not fire at each propagation cycle).

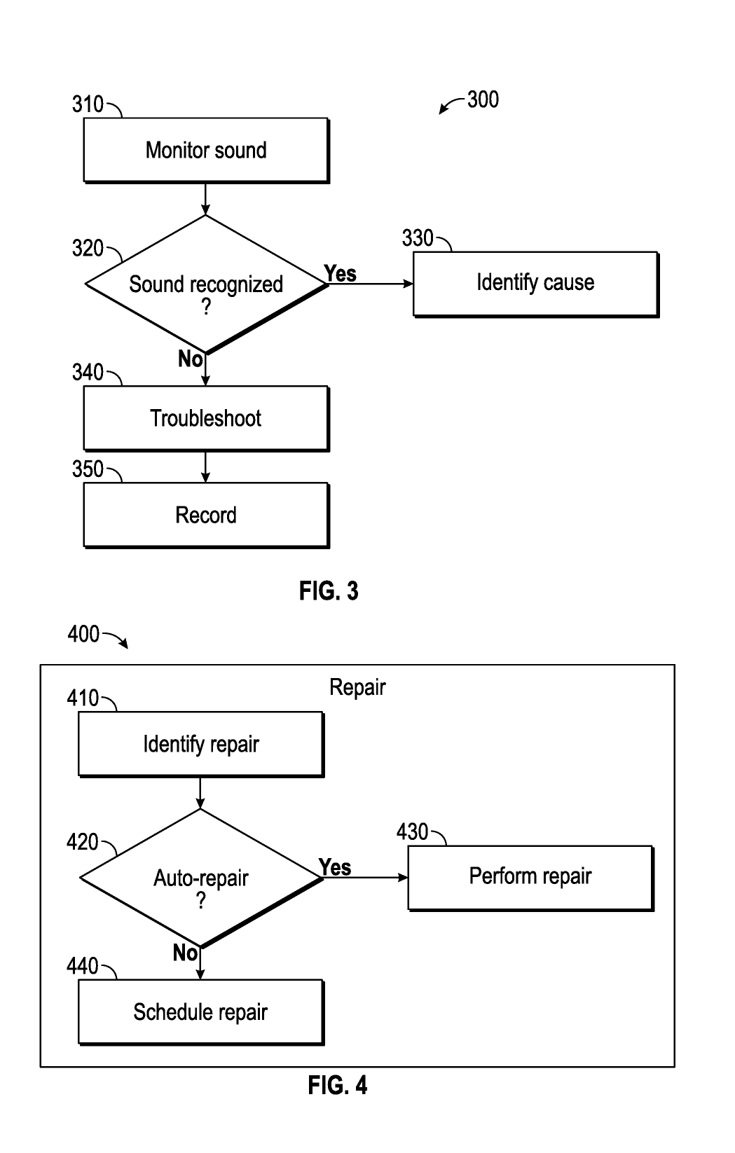

FIG. 3 illustrates an exemplary process 300 for determining the cause of a vehicle issue based on sounds according to examples of the disclosure. In some examples, process 300 can be performed when a vehicle issue has been detected based in part on a particular sound (or the vehicle issue is the particular sound coming from the vehicle).

At step 310, process 300 monitors sound(s) from various components of the vehicle such as the engine, wheels, transmission, suspension, and/or any other component of the vehicle through one or more sensors positioned at or near those various components (e.g., as described above with references to FIGS. 1-2).

At step 320, process 300 determines whether it recognizes a particular sound (e.g., whether there is a known cause of the particular sound). In some examples, process 300 can perform a lookup of the particular sound within a data structure (e.g., perform a database lookup) to determine whether the particular sound is associated with a known cause of that sound at step 320 (e.g., as described above with reference to FIG. 1). In accordance with a determination that the particular sound is associated with a known cause of the particular sound (e.g., data for the particular sound is found in the data structure), process 300 transitions to step 330. In accordance with a determination that the particular sound is not associated with a known cause for the particular sound, process 300 transitions to step 340. In some examples, the data structure can be a database, a hash table, a binary search tree, a data file, an XML, file, a binary decision diagram, or any other collection of vehicle sounds and the associated causes of each of those vehicle sounds. In some examples, the data structure can also include information about the repairs for the causes of each of the vehicle sounds (e.g., how to repair the cause of the vehicle sound or where to have the vehicle repaired). In some examples, a vehicle can maintain the data structure in its memory. In some examples, the data structure can be stored remotely (e.g., remote database(s) and/or cloud services), and the vehicle can perform the data structure lookup wirelessly (e.g., through a Wi-Fi connection or cellular connection). In some examples the data structure may be updated by the vehicle, other vehicles, the driver, a mechanic, a system administrator, and/or anyone troubleshooting a vehicle issue. In this way, a comprehensive data structure of vehicle issues and corresponding causes of those vehicle issues may be maintained and shared among many vehicles.

At step 330, process 300 retrieves the cause of the particular vehicle sound from the data structure. For example, process 300 can detect a loud sound coming from the motor at step 310, recognize the loud sound at step 320, and identify the cause as the oil requiring to be changed at step 330. In another example, process 300 can detect a squeaking sound coming from the brakes as a vehicle decelerates by using the brakes at step 310, recognize the squeaking sound at step 320, and identify the cause of the squeaking sound as worn out brake pads at step 330. In some examples, process 300 can notify the driver or a designated third party of the cause of the particular sound. In some examples, the vehicle can provide a visual alert through the vehicle's one or more display systems (e.g., control panel, entertainment system, heads up display system, or infotainment system). In some examples, the vehicle can provide an audio alert through the vehicle's sound system. In some examples, the alert can be a phone call, text message, email, or any form of electronic or audible/visual communication to an electronic device associated with the vehicle's owner, driver, passenger(s), or any third party (e.g., smartphone and/or other electronic device). The designated third party can be the vehicle's owner, a call center, a 911 operator, and/or any other third party. In some examples, the designated third party can be located in the vehicle or can be located remotely from the vehicle.

At step 340, the cause of the particular sound is manually troubleshot. For example, a mechanic, a dealer, the driver, the owner, or any third party may manually diagnose the cause of the particular sound. Once the cause of the particular sound is manually determined, process 300 transitions to step 350. At step 350, process 350 stores the particular sound and the cause of that particular sound (and any other relevant information such as how to repair the cause of the particular sound) in the data structure (e.g., as described above with references to FIGS. 1-2). In some examples, process 300 directly transitions from step 320 to step 350 in accordance with a determination that the particular sound is not associated with a known cause for the particular sound, and step 350 simply records the particular sound into the data structure (e.g., without recording the cause of the particular sound). At a later time, the driver, a mechanic, a dealer, the owner, or any third party can then update the entry with the cause of the particular sound and any other relevant information (e.g., how to repair the cause of the particular sound or where to have the vehicle repaired).

FIG. 4 illustrates an exemplary process 400 for making vehicle repairs according to examples of the disclosure. In some examples, process 400 can implement step 140 of process 100 (e.g., as described above with reference to FIG. 1).

At step 410, process 400 identifies how to repair a cause of a vehicle issue. In some examples, process 400 can perform a lookup of a vehicle issue on a data structure (e.g., perform a database lookup) to determine the cause of the vehicle issue and how to repair that cause of the vehicle issue at step 410 (e.g., as described above with references to FIGS. 1-3). In some examples, the data structure can be a database, a hash table, a binary search tree, a data file, an XML file, a binary decision diagram, or any other collection of vehicle issues, the associated causes of each of those vehicle issues, and the associated repairs for those vehicle issues (e.g., how to repair the cause of the vehicle sound or where to have the vehicle repaired). In some examples, a vehicle can maintain the data structure in its memory. In some examples, the data structure can be stored remotely (e.g., remote database(s) and/or cloud service(s)), and the vehicle can perform the data structure lookup wirelessly (e.g., through a Wi-Fi connection or cellular connection). In some examples the data structure may be updated by the vehicle, other vehicles, the driver, a mechanic, a system administrator, and/or anyone troubleshooting a vehicle issue. In this way, a comprehensive data structure of vehicle issues and corresponding causes of those vehicle issues may be maintained and shared among many vehicles.

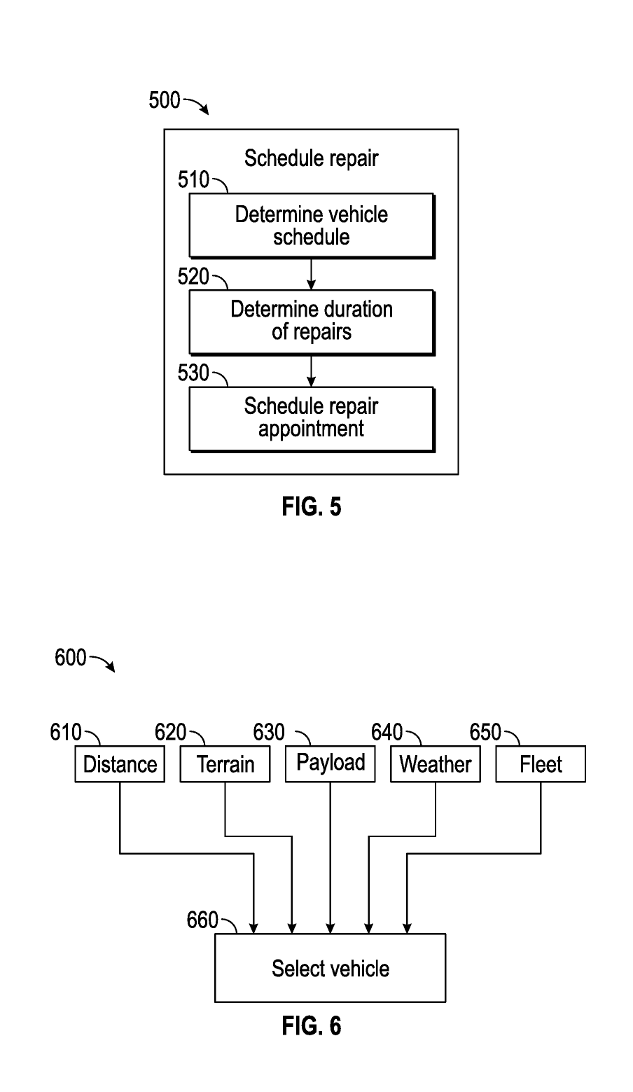

At step 420, process 400 determines whether the cause of the vehicle issue is automatically repairable (e.g., whether the vehicle can fix itself). In accordance with a determination that the cause of the vehicle issue is automatically repairable, process 400 transitions to step 430. In accordance with a determination that the cause of the vehicle issue is not automatically repairable, process 400 transitions to step 440. At step 440, process 400 can schedule an appointment for a repair at a later time, as described below with reference to FIG. 5. In some examples, information on whether the cause of the vehicle issue is automatically repairable can be retrieved with the data structure lookup performed at step 410.

At step 430, the vehicle automatically repairs itself at the current time. For example, the vehicle issue can be difficulty detecting objects in the vehicles surrounding with its LIDAR sensors. The cause of that vehicle issue can be a miscalibrated LIDAR sensor, which would require that the LIDAR sensor be calibrated. The automatic calibration of the LIDAR can be performed at step 430. Automatic LIDAR sensor calibration techniques are well known in the art. In another example, the cause of the vehicle issue can be malware, and the repair may be running anti-virus software. Process 430 can automatically run anti-virus software at step 430. In another example, the cause of the vehicle can be a wireless connection issue (e.g., Bluetooth, Wi-Fi, or cellular connection issue), and the repair may be resetting the wireless communication settings. Process 430 can automatically reset the wireless communication settings. In another example, the repair may be to replace vehicle fluids (e.g., oil, brake fluid, transmission fluid, power steering fluid, or radiator fluid). In some examples, the replacing of vehicle fluids may be automated. For example, an automated service center can be established for autonomous vehicles. This automated service center can be equipped with robotic arms. These robotic arms can have sensors to find the cap that can be removed to drain a particular vehicle fluid and a cap that can be used to refill the fluid. An autonomous vehicle can enter this service center and communicate with the service center that it needs an oil change (e.g., through a Wi-Fi connection, cellular connection, Bluetooth connection, or any other wireless connection). The service center can maintain a database of vehicle fluid information for particular vehicles (e.g., the grade of the motor oil and the amount of motor oil required for each vehicle) and automatically change the fluid for the vehicle (e.g., without human intervention during the process).

FIG. 5 illustrates an exemplary process 500 for automatically scheduling an appointment for repairs according to examples of the disclosure. In some examples, process 500 can implement step 440 of process 400 (e.g., as described above with reference to FIG. 4).

At step 510, process 500 can determine the vehicle's driving schedule. For example, process 500 can monitor vehicle operations (including location and duration the vehicle remains at that location) to recognize patterns at step 510. For instance, process 500 can recognize that the vehicle remains idle from 9 a.m. to 5 p.m., Monday through Friday (e.g., while the vehicle owner is at work). In some examples, the vehicle may be a part of a fleet of vehicles (e.g., a taxi cab, a big rig truck, or a shuttle), with a set schedule set by an administrator or centralized system. In such a case, process 500 can access that schedule at step 510 wirelessly (e.g., through a Wi-Fi connection, cellular connection, or Bluetooth connection). In some examples, process 500 can prompt the driver to enter the vehicle's schedule manually (e.g., enter dates and times the vehicle will be available for repairs). In some examples, the prompt can be a visual, haptic, and/or audio notification to the driver requesting the vehicle's schedule. In some examples, the notification can be on any of the vehicle's display system(s) (e.g., the control, entertainment, infotainment, and/or heads up display system(s)), a smartphone, or any other electronic device with a display. In some examples, the vehicle can provide an audible notification through the vehicle's speaker(s) or any other sound source in the vehicle. In some examples, the notification can be a phone call, text message, email, or any form of electronic or audible/visual communication to an electronic device. In some examples, the driver can enter the vehicle's schedule through a control system such as a button, a touch screen, a voice command, a computer, a smartphone, an electroencephalogram (EEG), or any device or system that allows user input to be entered.

At step 520, process 500 can determine the duration of the repairs according to examples of the disclosure. In some examples, this information can be retrieved at step 410 of process 400 (e.g., as described above with reference to FIG. 4). For example, the duration of a particular repair may be stored in a data structure entry (e.g., as described above with references to FIGS. 1-4). In some examples, process 500 calculates the duration of the commute to and from the repair location, and adds that travel time to the retrieved duration of repairs.

At step 530, process 500 can schedule the repair appointment. For example, process 500 can determine a time slot within the vehicle's schedule (e.g., the schedule determined at step 510) that will accommodate the duration of the repairs (e.g., the duration determined at step 520). In some examples, process 500 will communicate (e.g., through a Wi-Fi connection or cellular connection) with the repair location (e.g., a mechanic's shop, a dealership, an auto-parts shop, and a service center) to coordinate a repair/service appointment. In some examples, process 500 can prompt the driver to confirm or reject the service appointment through a control system such as a button, a touch screen, a voice command, a computer, a smartphone, an electroencephalogram (EEG), or any device or system that allows user input to be entered. In some examples, the driver can alter the service appointment through a control system. In some examples, process 500 can confirm the repair appointment with the repair location (e.g., reserve the time slot for the repairs). In some examples, the vehicle can autonomously navigate itself to and from the repair location at the designated time for the scheduled repair/service appointment. In some examples, the vehicle can automatically pay for the repair services with RFID or other wireless technology. In some examples, process 500 can notify the driver of the progress of the repair/service appointment. This notification can include the location of the vehicle and a status of the repairs. In some examples, the notification can be a phone call, text message, email, or any form of electronic or audible/visual communication to an electronic device.

FIG. 6 illustrates an exemplary process 600 for selecting a fleet vehicle to drive a particular route according to examples of the disclosure. At step 610, process 600 determines the distance of the route using map information. At step 620, process 600 determines the terrain information about the route using map information. At step 630, process 600 can monitor the payload for the route (e.g., the type of cargo, the weight of the cargo, the size of the cargo, and/or the number of passengers). At step 640, process 600 monitors weather information for the locations throughout the route on the planned dates and times for when the fleet vehicle will be in certain locations. In some examples, this weather information can be obtained through the internet (e.g., through an online weather service). In some examples, map information may be obtained through the internet (e.g., an online map service). At step 650, process 600 monitors fleet information that includes maintenance schedules (e.g., as described above with reference to FIG. 1). In some examples, process 600 can monitor how the operation of fleet vehicles are adapted for vehicle issues and/or the causes of those vehicle issues (e.g., as described above with reference to FIG. 1). At step 660, process 600 can determine which fleet vehicle will drive a particular route based on information from one or more of steps 610, 620, 630, 640, and 650. For example, a particular route can require a vehicle to drive 1,000 miles with a payload of 2,000 pounds. The terrain for the route can include a 100-mile stretch of hills and icy weather conditions. The vehicle fleet can include three available vehicles. The first vehicle can require an oil change in 700 miles, for example. The second vehicle can have battery issues and can drive for only 800 miles before the battery or battery string will need to be replaced, for example. The third vehicle can have worn out tires that will need to be changed in 200 miles and can carry a maximum payload of 1,000 pounds, for example. Therefore, process 600 would select the second vehicle to drive the route.

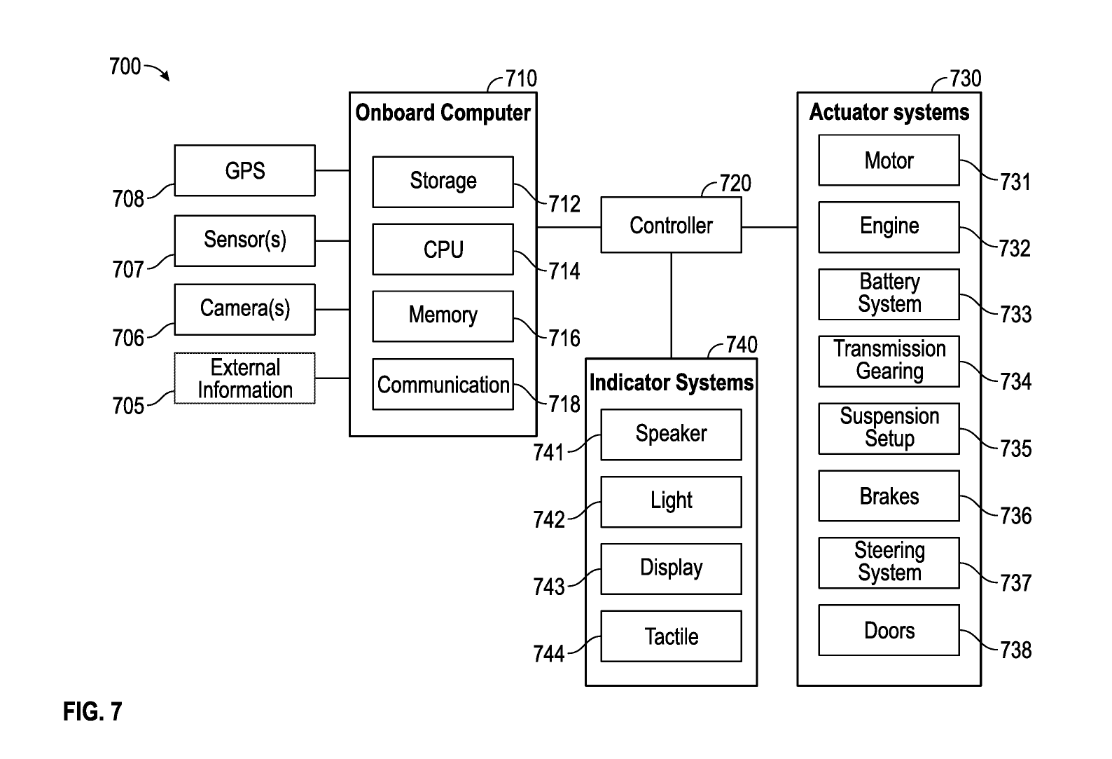

FIG. 7 illustrates an exemplary system block diagram of vehicle control system 700 according to examples of the disclosure. Vehicle control system 700 can perform any of the methods described with references to FIGS. 1-6. Vehicle control system 700 can be incorporated into a vehicle, such as a consumer automobile. Other examples of vehicles that may incorporate the vehicle control system 700 include, without limitation, airplanes, boats, or industrial automobiles. Vehicle control system 700 can include one or more cameras 706 capable of capturing image data (e.g., video data) for determining various characteristics of the vehicle's surroundings and/or information about vehicle components, as described above with reference to FIGS. 1-6. Vehicle control system 700 can also include one or more other sensors 707 (e.g., radar, ultrasonic, LIDAR, accelerometer, or gyroscope), and a GPS receiver 708. In some examples, sensor data can be fused together. This fusion can occur at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. ECU malfunction can also be addressed through the processes described above with reference to FIGS. 1-6. Vehicle control system 700 can also receive (e.g., via an internet connection) external information such as map and/or weather information from other vehicles or from an internet source via an external information interface 705 (e.g., a cellular Internet interface or a Wi-Fi Internet interface). Vehicle control system 700 can include an on-board computer 710 that is coupled to cameras 706, sensors 707, GPS receiver 708, and map information interface 705, and that is capable of receiving the image data from the cameras and/or outputs from the sensors 707, the GPS receiver 708, and the external information interface 705. On-board computer 710 can include storage 712, memory 716, and a processor 714. Processor 714 can perform any of the methods described with references to FIGS. 1-6. Additionally, storage 712 and/or memory 716 can store data and instructions for performing any of the methods described with references to FIGS. 1-6. Storage 712 and/or memory 716 can be any non-transitory computer readable storage medium, such as a solid-state drive or a hard disk drive, among other possibilities. The vehicle control system 700 can also include a controller 720 capable of controlling one or more aspects of vehicle operation, such as performing autonomous or semi-autonomous driving maneuvers and/or adapting vehicle operations as described above with references to FIGS. 1-6.

In some examples, vehicle control system 700 can be connected (e.g., via controller 720) to one or more actuator systems 730 in the vehicle and one or more indicator systems 740 in the vehicle. The one or more actuator systems 730 can include, but are not limited to, a motor 731 or engine 732, battery system 733, transmission gearing 734, suspension setup 735, brakes 736, steering system 737, and door system 738. Vehicle control system 700 can control, via controller 720, one or more of these actuator systems 730 during vehicle operation; for example, to open or close one or more of the doors of the vehicle using the door actuator system 738, to control the vehicle during autonomous driving or parking operations, using the motor 731 or engine 732, battery system 733, transmission gearing 734, suspension setup 735, brakes 736, and/or steering system 737, etc. The one or more indicator systems 740 can include, but are not limited to, one or more speakers 741 in the vehicle (e.g., as part of an entertainment system in the vehicle), one or more lights 742 in the vehicle, one or more displays 743 in the vehicle (e.g., as part of a control or entertainment system in the vehicle), and one or more tactile actuators 744 in the vehicle (e.g., as part of a steering wheel or seat in the vehicle). Vehicle control system 700 can control, via controller 720, one or more of these indicator systems 740 to provide indications to a driver.

Thus, the examples of the disclosure provide various ways to automate the servicing of vehicles.

Therefore, according to the above, some examples of the disclosure are directed to a system comprising: one or more sensors; one or more processors coupled to the one or more sensors; and a memory including instructions, which when executed by the one or more processors, cause the one or more processors to perform a method comprising: while monitoring a vehicle's operations: detecting a vehicle issue via the one or more sensors; determining a cause of the vehicle issue by performing a lookup on a data structure; determining whether the cause of the vehicle issue requires immediate repairs; and in response to determining whether the cause of the vehicle issue requires immediate repairs: in accordance with a determination that the cause of the vehicle issue requires immediate repairs, addressing the vehicle issue at a current time; in accordance with a determination that the cause of the vehicle issue does not require immediate repairs, adapting operation of the vehicle based on the cause of the vehicle issue, and addressing the vehicle issue at a later time. Additionally or alternatively to one or more of the examples disclosed above, in some examples, the data structure is one or more of a database, a hash table, a binary search tree, a data file, an XML file, and a binary decision diagram. Additionally or alternatively to one or more of the examples disclosed above, in some examples, the data structure is located remotely. Additionally or alternatively to one or more of the examples disclosed above, in some examples, determining the cause of the vehicle issue comprises: monitoring one or more vehicle sounds via the one or more sensors; determining whether the one or more vehicle sounds are associated with a known cause of the one or more vehicle sounds; and in response to determining whether the one or more vehicle sounds are associated with a known cause of the one or more vehicle sounds: in accordance with a determination that the one or more vehicle sounds are associated with a known cause of the one or more vehicle sounds, automatically identifying a known cause of the one or more vehicle sounds; in accordance with a determination that the one or more vehicle sounds are not associated with a known cause of the one or more vehicle sounds, manually troubleshooting a cause of the of the one or more vehicle sounds and recording the cause of the one or more sounds as the known cause of the one or more vehicle sounds. Additionally or alternatively to one or more of the examples disclosed above, in some examples, the method further comprises: in accordance with a determination that the one or more vehicle sounds are not associated with a known cause of the one or more vehicle sounds, recording one or more repairs required to repair the known cause of the one or more vehicle sounds. Additionally or alternatively to one or more of the examples disclosed above, in some examples, adapting the operation of the vehicle comprises one or more of: rerouting the vehicle; avoiding driving routes longer than a threshold distance; avoiding particular weather conditions; avoiding particular terrains; avoiding payloads heavier than a threshold weight; updating vehicle fleet information; and calibrating the one or more sensors. Additionally or alternatively to one or more of the examples disclosed above, in some examples, the vehicle issue is a low oil level; the cause of the vehicle issue is normal wear and tear; the normal wear and tear does not require immediate repairs; and adapting the operation of the vehicle comprises avoiding driving routes longer than a threshold distance. Additionally or alternatively to one or more of the examples disclosed above, in some examples, the vehicle issue is the vehicle can only charge its power to a level below the vehicle's maximum capacity; the cause of the vehicle issue is battery malfunctions; the battery malfunctions do not require immediate repairs; and adapting the operation of the vehicle comprises avoiding particular terrains, wherein avoiding particular terrains comprises avoiding hilly terrains. Additionally or alternatively to one or more of the examples disclosed above, in some examples, the vehicle issue is skidding during turning maneuvers; the cause of the vehicle issue is tire wear; the tire wear does not require immediate repairs; and adapting the operation of the vehicle comprises avoiding particular weather conditions, wherein the particular weather conditions comprises rainy or icy conditions. Additionally or alternatively to one or more of the examples disclosed above, in some examples, the one or more sensors includes one or more cameras; the vehicle issue is difficulty detecting objects with the one or more cameras; the cause of the vehicle issue is fog; the fog does not require immediate repairs; and adapting the operation of the vehicle comprises rerouting the vehicle to avoid the fog. Additionally or alternatively to one or more of the examples disclosed above, in some examples, notifying the driver of the vehicle issue and the cause of the vehicle issue. Additionally or alternatively to one or more of the examples disclosed above, in some examples, addressing the vehicle issue comprises: identifying one or more repairs required for the vehicle issue; determining whether the cause of the vehicle issue is automatically repairable: in response to the determination: in accordance with a determination that the cause of the issue is automatically repairable, automatically repairing the cause of the vehicle issue; in accordance with a determination that the cause of the issue is not automatically repairable, scheduling a repair appointment to repair the cause of the vehicle issue. Additionally or alternatively to one or more of the examples disclosed above, in some examples, scheduling the repair appointment comprises: determining a vehicle schedule; determining a duration of the one or more repairs required for the vehicle issue; identifying a time for the repair appointment; and reserving the time for the repair appointment. Additionally or alternatively to one or more of the examples disclosed above, in some examples, navigating the vehicle from a starting location to a repair location at the time for the repair appointment; and navigating the vehicle from the repair location to the starting location upon completion of the one or more repairs. Additionally or alternatively to one or more of the examples disclosed above, in some examples, the repair location is one of a mechanic's shop, a dealership, an auto-parts shop, and a service center. Additionally or alternatively to one or more of the examples disclosed above, in some examples, notifying a driver of the vehicle about a progress of the repair appointment, wherein the progress of the repair appointment comprises one or more of a location of the vehicle and a status of the one or more repairs. Additionally or alternatively to one or more of the examples disclosed above, in some examples, paying for the one or more repairs through RFID technology.

Some examples of the disclosure are directed to a non-transitory computer-readable medium including instructions, which when executed by one or more processors, cause the one or more processors to perform a method comprising: while monitoring a vehicle's operations: detecting a vehicle issue via one or more sensors; determining a cause of the vehicle issue by performing a lookup on a data structure; determining whether the cause of the vehicle issue requires immediate repairs; and in response to determining whether the cause of the vehicle issue requires immediate repairs: in accordance with a determination that the cause of the vehicle issue requires immediate repairs, addressing the vehicle issue at a current time; in accordance with a determination that the cause of the vehicle issue does not require immediate repairs, adapting operation of the vehicle based on the cause of the vehicle issue, and addressing the vehicle issue at a later time.

Some examples of the disclosure are directed to a vehicle comprising: one or more sensors; one or more processors coupled to the one or more sensors; and a memory including instructions, which when executed by the one or more processors, cause the one or more processors to perform a method comprising: while monitoring the vehicle's operations: detecting a vehicle issue via the one or more sensors; determining a cause of the vehicle issue by performing a lookup on a data structure; determining whether the cause of the vehicle issue requires immediate repairs; and in response to determining whether the cause of the vehicle issue requires immediate repairs: in accordance with a determination that the cause of the vehicle issue requires immediate repairs, addressing the vehicle issue at a current time; in accordance with a determination that the cause of the vehicle issue does not require immediate repairs, adapting operation of the vehicle based on the cause of the vehicle issue, and addressing the vehicle issue at a later time.

Some examples of the disclosure are directed to a method comprising: while monitoring a vehicle's operations: detecting a vehicle issue via one or more sensors; determining a cause of the vehicle issue by performing a lookup on a data structure; determining whether the cause of the vehicle issue requires immediate repairs; and in response to determining whether the cause of the vehicle issue requires immediate repairs: in accordance with a determination that the cause of the vehicle issue requires immediate repairs, addressing the vehicle issue at a current time; in accordance with a determination that the cause of the vehicle issue does not require immediate repairs, adapting operation of the vehicle based on the cause of the vehicle issue, and addressing the vehicle issue at a later time.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more sensors;
one or more processors coupled to the one or more sensors; and
a memory including instructions, which when executed by the one or more processors, cause the one or more processors to perform a method comprising:
while monitoring a vehicle's operations:
detecting a vehicle issue via the one or more sensors;
determining a cause of the vehicle issue by performing a lookup on a data structure;
determining whether the cause of the vehicle issue requires immediate repairs; and
in response to determining whether the cause of the vehicle issue requires immediate repairs:
in accordance with a determination that the cause of the vehicle issue requires immediate repairs, addressing the vehicle issue at a current time;
in accordance with a determination that the cause of the vehicle issue does not require immediate repairs, adapting operation of the vehicle based on the cause of the vehicle issue, and addressing the vehicle issue at a later time.

2. The system of claim 1, wherein the data structure is one or more of a database, a hash table, a binary search tree, a data file, an XML file, and a binary decision diagram.

3. The system of claim 2, wherein the data structure is located remotely.

4. The system of claim 1, wherein:
determining the cause of the vehicle issue comprises:
monitoring one or more vehicle sounds via the one or more sensors;
determining whether the one or more vehicle sounds are associated with a known cause of the one or more vehicle sounds; and
in response to determining whether the one or more vehicle sounds are associated with a known cause of the one or more vehicle sounds:
in accordance with a determination that the one or more vehicle sounds are associated with a known cause of the one or more vehicle sounds, automatically identifying a known cause of the one or more vehicle sounds;
in accordance with a determination that the one or more vehicle sounds are not associated with a known cause of the one or more vehicle sounds, manually troubleshooting a cause of the of the one or more vehicle sounds and recording the cause of the one or more sounds as the known cause of the one or more vehicle sounds.

5. The system of claim 4, wherein the method further comprises:
in accordance with a determination that the one or more vehicle sounds are not associated with a known cause of the one or more vehicle sounds, recording one or more repairs required to repair the known cause of the one or more vehicle sounds.

6. The system of claim 1, wherein:
adapting the operation of the vehicle comprises one or more of:
rerouting the vehicle;
avoiding driving routes longer than a threshold distance;
avoiding particular weather conditions;
avoiding particular terrains;
avoiding payloads heavier than a threshold weight;
updating vehicle fleet information; and
calibrating the one or more sensors.

7. The system of claim 6, wherein:
the vehicle issue is a low oil level;
the cause of the vehicle issue is normal wear and tear;
the normal wear and tear does not require immediate repairs; and
adapting the operation of the vehicle comprises avoiding driving routes longer than a threshold distance.

8. The system of claim 6, wherein:
the vehicle issue is the vehicle can only charge its power to a level below the vehicle's maximum capacity;
the cause of the vehicle issue is battery malfunctions;
the battery malfunctions do not require immediate repairs; and
adapting the operation of the vehicle comprises avoiding particular terrains, wherein avoiding particular terrains comprises avoiding hilly terrains.

9. The system of claim 6, wherein:
the vehicle issue is skidding during turning maneuvers;
the cause of the vehicle issue is tire wear;
the tire wear does not require immediate repairs; and
adapting the operation of the vehicle comprises avoiding particular weather conditions, wherein the particular weather conditions comprises rainy or icy conditions.

10. The system of claim 6, wherein:
the one or more sensors includes one or more cameras;
the vehicle issue is difficulty detecting objects with the one or more cameras;
the cause of the vehicle issue is fog;
the fog does not require immediate repairs; and
adapting the operation of the vehicle comprises rerouting the vehicle to avoid the fog.

11. The system of claim 1, wherein the method further comprises notifying the driver of the vehicle issue and the cause of the vehicle issue.

12. The system of claim 1, wherein:
addressing the vehicle issue comprises:
identifying one or more repairs required for the vehicle issue;
determining whether the cause of the vehicle issue is automatically repairable:
in response to the determination:
in accordance with a determination that the cause of the issue is automatically repairable, automatically repairing the cause of the vehicle issue;
in accordance with a determination that the cause of the issue is not automatically repairable, scheduling a repair appointment to repair the cause of the vehicle issue.

13. The system of claim 12, wherein:
scheduling the repair appointment comprises:
determining a vehicle schedule;
determining a duration of the one or more repairs required for the vehicle issue;
identifying a time for the repair appointment; and
reserving the time for the repair appointment.

14. The system of claim 13, wherein the method further comprises:
navigating the vehicle from a starting location to a repair location at the time for the repair appointment; and
navigating the vehicle from the repair location to the starting location upon completion of the one or more repairs.

15. The system of claim 14, wherein the repair location is one of a mechanic's shop, a dealership, an auto-parts shop, and a service center.

16. The system of claim 14, wherein the method further comprises notifying a driver of the vehicle about a progress of the repair appointment, wherein the progress of the repair appointment comprises one or more of a location of the vehicle and a status of the one or more repairs.

17. The system of claim 14, wherein the method further comprises paying for the one or more repairs through RFID technology.

18. A non-transitory computer-readable medium including instructions, which when executed by one or more processors, cause the one or more processors to perform a method comprising:
while monitoring a vehicle's operations:
detecting a vehicle issue via one or more sensors;
determining a cause of the vehicle issue by performing a lookup on a data structure;
determining whether the cause of the vehicle issue requires immediate repairs; and
in response to determining whether the cause of the vehicle issue requires immediate repairs:
in accordance with a determination that the cause of the vehicle issue requires immediate repairs, addressing the vehicle issue at a current time;
in accordance with a determination that the cause of the vehicle issue does not require immediate repairs, adapting operation of the vehicle based on the cause of the vehicle issue, and addressing the vehicle issue at a later time.

19. A vehicle comprising:
one or more sensors;
one or more processors coupled to the one or more sensors; and
a memory including instructions, which when executed by the one or more processors, cause the one or more processors to perform a method comprising:
while monitoring the vehicle's operations:
detecting a vehicle issue via the one or more sensors;
determining a cause of the vehicle issue by performing a lookup on a data structure;
determining whether the cause of the vehicle issue requires immediate repairs; and
in response to determining whether the cause of the vehicle issue requires immediate repairs:
in accordance with a determination that the cause of the vehicle issue requires immediate repairs, addressing the vehicle issue at a current time;
in accordance with a determination that the cause of the vehicle issue does not require immediate repairs, adapting operation of the vehicle based on the cause of the vehicle issue, and addressing the vehicle issue at a later time.
